(19) United States
(12) Patent Application Publication
(10) Pub. No.: US 2021/0030220 A1
(43) Pub. Date: Feb. 4, 2021

(54) PeeWee Waterslide

(71) Applicant: Stephanie Ann Green, Milwaukie, OR (US)

(72) Inventor: Stephanie Ann Green, Milwaukie, OR (US)

(21) Appl. No.: 16/530,287

(22) Filed: Aug. 2, 2019

(51) Int. Cl. A47K 11/04; G09B 19/00

(52) U.S. Cl. CPC A47K 11/04; G09B 19/0076

(57) ABSTRACT

The purpose of this patent application is to obtain a patent on the PeeWee Waterslide potty training tool. The main purpose for this invention is to benefit caretakers in terms of helping to eliminate urine on surfaces. Also this will help train kids to aim properly into the toilet. Kids will also learn quicker and become very excited about wanting to use the toilet instead of diapers.

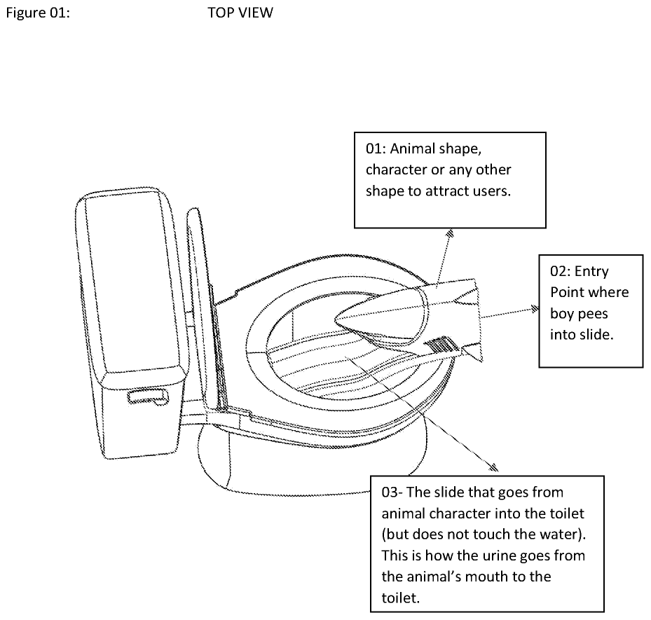

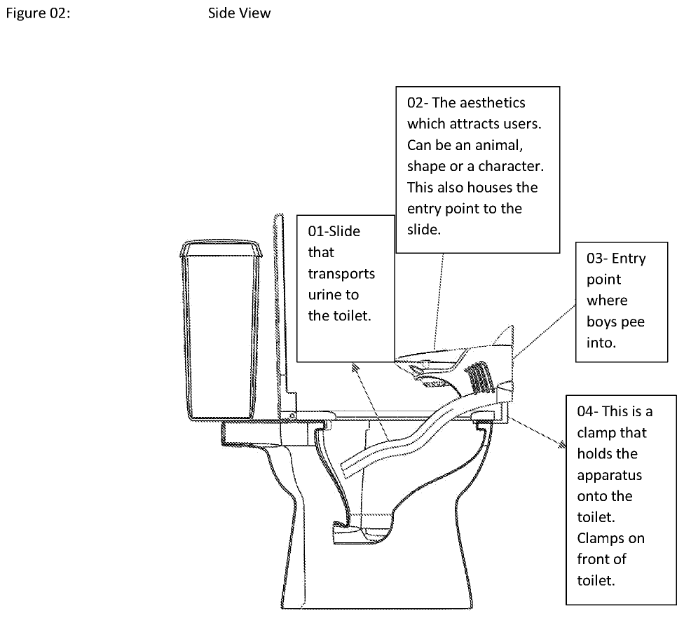

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention is a new invention in which no patents or ideas already exist. This is a brand new product that will be brought to the market. This invention does not improve any other product on the market. It is a new product and that is standalone. The main impetus for the PeeWee Waterslide toilet training apparatus is to train boys to properly pee into the toilet while encouraging aim, while reducing excess urine to splash on the back of the toilet, floor and onto the seat. Kids aim into the animal face or character that is clipped onto the toilet and the pee goes down a slide into the toilet.

Stephanie Ann Green is a full time working mother of 3 small kids with an MBA. Her house is comprised of 3 males and she is constantly trying to teach them to pee into the actual toilet instead of on the floor or on the back seat of the toilet. On an average day, she wipes off urine from her toilet 5 times a day and not to mention the bad urine smell that emulates in the bathroom. One day she was teaching her youngest child to try and pee into the existing base hole of the toilet and said “pretend it is a waterslide and try and shoot down the hole”. That minute the PeeWee Waterslide was invented as a training tool for kids; to teach better aim and to alleviate urine on surfaces.

### BRIEF SUMMARY OF THE INVENTION

As mentioned above, there is a huge market and need for this product. The invention is comprised of an animal, shape or character (all items or designs on the slide are in scope) that is clipped onto the front of the toilet where the kids aim and pee through an entry point (like the mouth of an animal), and then the exit of the mouth has a slide that goes down into the toilet bowl and exits before it hits the toilet water. Due to the flexible accordion type of the mount, mentioned above, the waterslide can move to any height of the child.

### BRIEF DESCRIPTION OF THE SEVERAL VIEWS OF THE DRAWING

Please refer to separate diagram of the PeeWee Waterslide. Each element is properly labeled.

### DETAILED DESCRIPTION OF THE INVENTION

There is no other invention like this one the market. This is not an improved product patent either. The process is simple with existing materials on the market. All materials are on the market currently so it's a matter of assembling existing materials that are commercially available. This invention requires the use of a cool or attractive entry point (like an animal character or any other design) and after the pee enters the entry point, it goes down a slide to the toilet. Kids pee into the animal mouth or whatever design it may be (aka entry point), and watch their pee go down the slide to the toilet (exit point).

1. A potty training tool that sits on top of a toilet and has an attractive entry point, such as an animal face or character or shape, that is used as a target for boys to urinate into, and out the entry point is a slide that the urine flows down into the toilet.
(a) A potty-training tool with an attached slide that mounts onto the toilet to help boys potty train.
(b) The entry point of the slide is an animal, shape or character that clips or mounts onto the toilet.
(c) The urine flows from the entry point, down a slide to the back the toilet.
